(19) United States
(12) Patent Application Publication
(10) Pub. No.: US 2017/0273017 A1
(43) Pub. Date: Sep. 21, 2017

(54) REQUEST-TO-SEND/CLEAR-TO-SEND ENABLED POWER SAVING AND OFF-CHANNEL OPERATIONS

(71) Applicant: QUALCOMM Incorporated, San Diego, CA (US)

(72) Inventors: Ravi Gidvani, Fremont, CA (US); Sandip HomChaudhuri, San Jose, CA (US); Vikram Phogat, San Jose, CA (US)

(21) Appl. No.: 15/452,660

(22) Filed: Mar. 7, 2017

Related U.S. Application Data
(60) Provisional application No. 62/310,610, filed on Mar. 18, 2016.

(51) Int. Cl. H04W 52/02; H04W 24/10

(52) U.S. Cl. CPC H04W 52/0206; H04W 24/10

(57) ABSTRACT

Methods, systems, and devices for wireless communication are described. An access point (AP) may direct stations (STAs) to use a request-to-send (RTS)/clear-to-send (CTS) mode so the AP may perform power savings and off-channel operations without disrupting the communications of nearby devices. In some cases, the AP may use traffic conditions to identify a power save period and subsequently transmit an indication of an RTS/CTS mode to multiple STAs. In one example, the AP may power down at least one radio frequency (RF) chain and enter into a sleep mode. Additionally or alternatively, during the power save period the AP may receive an RTS from a STA and power up additional radio chains for MIMO communication. In some cases, the AP may identify an off-channel operations period based on traffic conditions and perform the off-channel operations after indicating the RTS/CTS mode to a set of STAs.

### CROSS REFERENCES

The present Application for Patent claims priority to U.S. Provisional Patent Application No. 62/310,610 by Gidvani, et al., entitled “REQUEST-TO-SEND/CLEAR-TO-SEND ENABLED POWER SAVING AND OFF-CHANNEL OPERATIONS,” filed Mar. 18, 2016, assigned to the assignee hereof, and is hereby expressly incorporated by reference herein in its entirety.

### BACKGROUND

The following relates generally to wireless communication, and more specifically to request-to-send (RTS)/clear-to-send (CTS) enabled power saving and off-channel operations.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (Wi-Fi) (i.e., IEEE 802.11) network may include an access point (AP) that may communicate with at least one station (STA) or mobile device. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via a downlink (DL) and an uplink (UL). The DL (or forward link) may refer to the communication link from the AP to the STA, and the UL (or reverse link) may refer to the communication link from the STA to the AP.

An AP may support wireless communications with a number of STAs within a basic service set (BSS). However, in some cases, the traffic within the BSS may be light or sporadic. In these cases, the AP may expend a large amount of energy supporting little or no traffic. This may increase the expense of operating the AP or reduce the useful life of the device.

### SUMMARY

An access point (AP) may direct stations (STAs) to use a request-to-send (RTS)/clear-to-send (CTS) mode so the AP may perform power savings and off-channel operations without disrupting the communications of nearby devices. In some cases, the AP may use traffic conditions to identify a power save period and subsequently transmit an indication of an RTS/CTS mode to multiple STAs. In one example, the AP may power down at least one radio frequency (RF) chain and enter into a sleep mode. Additionally or alternatively, during the power save period, the AP may receive an RTS from a STA and power up additional radio chains (e.g., for multiple-input multiple-output (MIMO) communication). In some cases, the AP may identify an off-channel operations period based on traffic conditions and perform the off-channel operations after indicating the RTS/CTS mode to a set of STAs. In some examples, an AP may set protection mechanism bits in management frames, such as a beacon, to indicate to STAs to use the RTS/CTS mode such that the AP may perform power savings and off-channel operations.

A method of wireless communication is described. The method may include identifying, by an AP, a power save period based at least in part on a traffic condition, transmitting, from the AP, an indication of an RTS/CTS mode for the power save period and powering down at least one radio chain during the power save period based at least in part on the RTS/CTS mode.

An apparatus for wireless communication is described. The apparatus may include means for identifying, by an AP, a power save period based at least in part on a traffic condition, means for transmitting, from the AP, an indication of an RTS/CTS mode for the power save period and means for powering down at least one radio chain during the power save period based at least in part on the RTS/CTS mode.

Another apparatus is described. The apparatus may include a processor, memory in electronic communication with the processor, and instructions stored in the memory. The instructions may be operable to cause the processor to identify, by an AP, a power save period based at least in part on a traffic condition, transmit, from the AP, an indication of an RTS/CTS mode for the power save period and power down at least one radio chain during the power save period based at least in part on the RTS/CTS mode.

A non-transitory computer readable medium for wireless communication is described. The non-transitory computer-readable medium may include instructions to cause a processor to identify, by an AP, a power save period based on a traffic condition, transmit, from the AP, an indication of an RTS/CTS mode for the power save period and power down at least one radio chain during the power save period based on the RTS/CTS mode.

In some examples of the method, apparatus, or non-transitory computer-readable medium described above, powering down the at least one radio chain comprises: powering down each radio chain of a device according to a sleep mode configuration. In some examples of the method, apparatus, or non-transitory computer-readable medium described above, powering down the at least one radio chain comprises: powering down all power-collapsible hardware components, radio frequency (RF) components, and medium access control (MAC) components of a device.

Some examples of the method, apparatus, or non-transitory computer-readable medium described above may further include processes, features, means, or instructions for communicating, during the power save period, using an additional radio chain, where the at least one radio chain and the additional radio chain comprise different radio chains of a multiple-input, multiple-output (MIMO) configuration.

Some examples of the method, apparatus, or non-transitory computer-readable medium described above may further include processes, features, means, or instructions for receiving an RTS message from a STA during the power save period according to the RTS/CTS mode. Some examples of the method, apparatus, or non-transitory computer-readable medium described above may further include processes, features, means, or instructions for identifying a number of radio chains for MIMO communications with the STA based on the RTS message. Some examples of the method, apparatus, or non-transitory computer-readable medium described above may further include processes, features, means, or instructions for powering up one or more radio chains for the MIMO communications based on the identified number of radio chains.

Some examples of the method, apparatus, or non-transitory computer-readable medium described above may further include processes, features, means, or instructions for determining that a traffic metric for STAs within a basic service set (BSS) is less than a threshold, wherein the power save period is identified based at least in part on the determination that the traffic metric is less than the threshold.

In some examples of the method, apparatus, or non-transitory computer-readable medium described above, the indication directs STAs within a BSS to utilize the RTS/CTS mode during the power save period. In some examples of the method, apparatus, or non-transitory computer-readable medium described above, the power save period is identified based on a roaming trigger parameter for a STA. In some examples of the method, apparatus, or non-transitory computer-readable medium described above, transmitting the indication of the RTS/CTS mode comprises: setting an RTS/CTS packet size threshold to zero. In some examples of the method, apparatus, and non-transitory computer-readable medium described above, transmitting the indication of the RTS/CTS mode comprises: setting a protection bit in one or more management frames to indicate the RTS/CTS mode.

A method of wireless communication is described. The method may include identifying an off-channel operations period, transmitting an indication of an RTS/CTS mode for the off-channel operations period, wherein the indication is transmitted on a first channel and performing off-channel operations on a second channel during the off-channel operations period based at least in part on the RTS/CTS mode.

An apparatus for wireless communication is described. The apparatus may include means for identifying an off-channel operations period, means for transmitting an indication of an RTS/CTS mode for the off-channel operations period, wherein the indication is transmitted on a first channel and means for performing off-channel operations on a second channel during the off-channel operations period based at least in part on the RTS/CTS mode.

Another apparatus is described. The apparatus may include a processor, memory in electronic communication with the processor, and instructions stored in the memory. The instructions may be operable to cause the processor to identify an off-channel operations period, transmit an indication of an RTS/CTS mode for the off-channel operations period, wherein the indication is transmitted on a first channel and perform off-channel operations on a second channel during the off-channel operations period based at least in part on the RTS/CTS mode.

A non-transitory computer readable medium for wireless communication is described. The non-transitory computer-readable medium may include instructions to cause a processor to identify an off-channel operations period, transmit an indication of an RTS/CTS mode for the off-channel operations period, where the indication is transmitted on a first channel and perform off-channel operations on a second channel during the off-channel operations period based on the RTS/CTS mode.

In some examples of the method, apparatus, or non-transitory computer-readable medium described above, the off-channel operations comprise a component of a multi-channel concurrency operation. In some examples of the method, apparatus, or non-transitory computer-readable medium described above, the indication directs all STAs within a BSS to utilize the RTS/CTS mode during the off-channel operations period.

In some examples of the method, apparatus, or non-transitory computer-readable medium described above, the off-channel operations period is identified based on a roaming trigger parameter for a STA. In some examples of the method, apparatus, or non-transitory computer-readable medium described above, transmitting the indication of the RTS/CTS mode comprises: setting an RTS/CTS packet size threshold to zero. In some examples of the method, apparatus, and non-transitory computer-readable medium described above, transmitting the indication of the RTS/CTS mode comprises: setting a protection bit in one or more management frames to indicate the RTS/CTS mode.

### BRIEF DESCRIPTION OF THE DRAWINGS

FIG. 1 illustrates an example of a wireless communications system that supports RTS/CTS enabled power saving and off-channel operations in accordance with various aspects of the present disclosure;

FIGS. 2 through 4 illustrate examples of process flows in a system that supports RTS/CTS enabled power saving and off-channel operations in accordance with various aspects of the present disclosure;

FIGS. 5 through 7 show block diagrams of a wireless device that supports RTS/CTS enabled power saving and off-channel operations in accordance with various aspects of the present disclosure;

FIG. 8 illustrates a block diagram of a system including an AP that supports RTS/CTS enabled power saving and off-channel operations in accordance with various aspects of the present disclosure; and

FIGS. 9 through 12 illustrate methods for RTS/CTS enabled power saving and off-channel operations in accordance with various aspects of the present disclosure.

### DETAILED DESCRIPTION

Some wireless communications system may use channel reservation techniques such as request-to-send (RTS) and clear-to-send (CTS) procedures. RTS/CTS procedures may be used to control station (STA) access to a wireless medium. For example, a STA using RTS/CTS procedures may refrain from communicating on the medium until an RTS/CTS handshake is completed with another wireless device, such as an access point (AP). In some cases, a STA (or an AP) may transmit a CTS-to-self frame (e.g., a CTS frame that includes a medium access control (MAC) address of the transmitter in a receiver address (RA) field) that reserves the channel for the transmitter's own transmission. The CTS-to-self mechanism may announce to other devices in a basic service set (BSS) that the transmitter may be communicating for a specified period of time. As a result, the surrounding wireless devices may refrain from using the medium during this time (e.g., up to a maximum duration).

In some wireless communications systems, there may be no designated mechanism that allows an AP to go into a power save or sleep mode (e.g., powering down each RF chain of a radio) or perform off-channel operations (e.g., performing an active scan outside of an operating channel) while maintaining an existing connection. For example, an AP may send a CTS-to-self frame and perform off-channel operations, but the transmission of the CTS-to-self frame may only allow the AP to operate off-channel for a limited amount of time (e.g., a maximum of 32 ms) and may prevent other devices from communicating during the CTS-to-self frame.

However, as described herein, an AP may direct STAs to use an RTS/CTS mode, where the RTS/CTS mode may direct the use of RTS/CTS procedures (e.g., including an exchange of RTS and CTS between devices, or an exchange of CTS between devices) by one or more STAs in a BSS to allow the AP to enter a power save mode or to perform off-channel operations. In some cases, the AP may use channel conditions to determine whether to trigger the mechanism to direct STAs to use RTS/CTS procedures. In some cases, an AP may enforce RTS/CTS procedures so that it may transition into a sleep mode (e.g., powering down each RF chain of a radio) to save power. Additionally or alternatively, the AP may enforce RTS/CTS procedures to save power by turning off radio frequency (RF) chains. The RTS/CTS mode may also be directed to STAs so that an AP may perform off-channel operations.

Aspects of the disclosure are initially described in the context of a wireless communication system. Specific examples are then described for an AP entering into power save and off-channel operations using directed RTS/CTS procedures. Aspects of the disclosure are further illustrated by and described with reference to apparatus diagrams, system diagrams, and flowcharts that relate to RTS/CTS enabled power saving and off-channel operations.

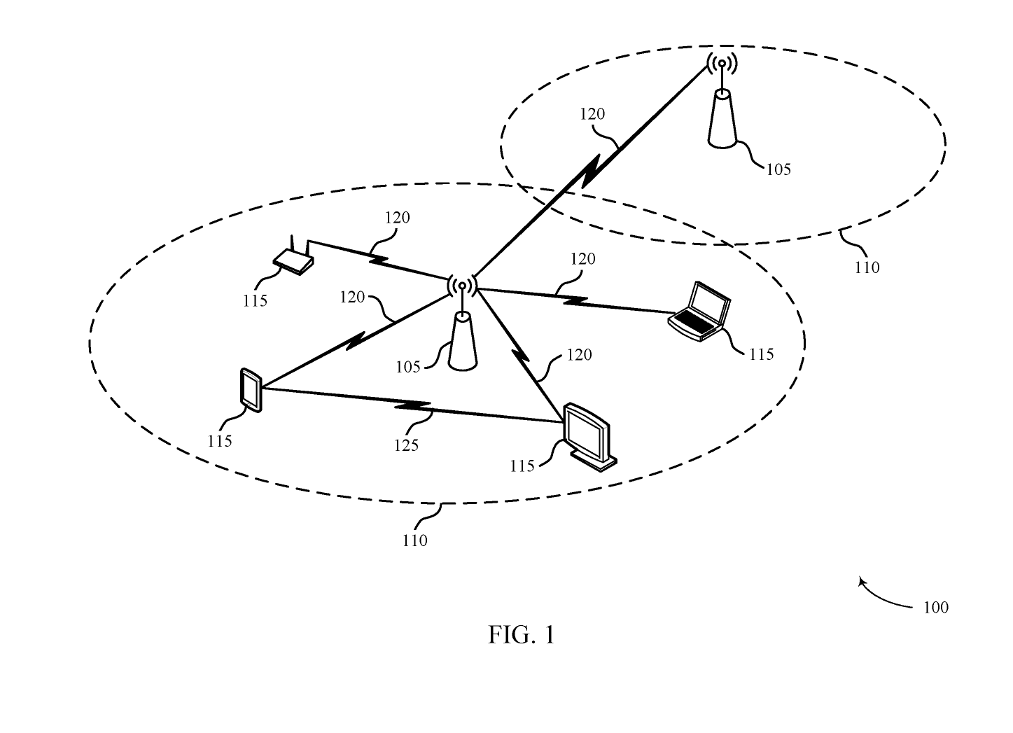

FIG. 1 illustrates a WLAN 100 (also known as a Wi-Fi network) configured in accordance with various aspects of the present disclosure. The WLAN 100 may include an AP 105 and multiple associated STAs 115, which may represent devices such as mobile stations, personal digital assistants (PDAs), other handheld devices, netbooks, notebook computers, tablet computers, laptops, display devices (e.g., TVs, computer monitors, etc.), printers, etc. The AP 105 and the associated STAs 115 may represent a BSS or an extended service set (ESS), where an ESS is a set of connected BSSs. The various STAs 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS. WLAN 100 may represent a network that supports an AP 105 directed RTS/CTS mode to allow efficient AP power saving and off-channel operations.

Although not shown in FIG. 1, a STA 115 may be located in the intersection of more than one coverage area 110 and may associate with more than one AP 105. A single AP 105 and an associated set of STAs 115 may be referred to as a BSS. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. In some cases, a second BSS may be present within a relatively close proximity of coverage area 110. The second BSS may be referred to as an overlapping basic service set (OBSS). In some cases, an OBSS may be a source of interference to at least one STA 115, where additional wireless devices associated with the OBSS may be referred to as hidden nodes and affect communications and throughput for the STAs 115.

In some cases, multiple APs 105 may communicate with each other over direct wireless links 120, and communication between the APs 105 may occur while maintaining direct wireless links 120 with STAs 115. For example, a first AP 105 in a multi-channel concurrency mode may operate within its own BSS on a first channel and concurrently communicate with a second AP 105 on a different channel. Thus, an AP 105 may perform off-channel operations by communicating with another BSS on a different channel.

Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100. In some cases, a second BSS may be present within a relatively close proximity of coverage area 110.

WLAN 100 may employ channel reservation techniques such as RTS and CTS procedures. RTS/CTS procedures may control STA 115 access to a wireless medium, and a STA 115 using RTS/CTS procedures may refrain from communicating on the medium until an RTS/CTS handshake can be completed with another wireless device, such as an AP 105. For example, a STA 115 may initiate an RTS/CTS exchange with an AP 105 by sending an RTS. The STA 115 may then wait to transmit data or control frames on the medium until the AP 105 responds with a corresponding CTS. A CTS frame may also contain a time field that alerts other STAs 115 to refrain from accessing the medium for a duration while the STA 115 that initiated the RTS communicates.

In some cases, a STA 115 (or an AP 105) may transmit a CTS-to-self frame (e.g., a CTS frame that includes a MAC address of the transmitter in an RA field) that reserves the channel for its own transmission. The CTS-to-self mechanism may announce to other devices in a BSS that the transmitter may be communicating for a specified period of time. As a result, the surrounding wireless devices may refrain from using the medium during this time (up to a maximum duration). For example, in a system that supports multi-channel concurrency, the duration indicated by a CTS-to-self frame may be 32.765 ms.

RTS/CTS techniques may be used to resolve interference from hidden nodes (e.g., wireless nodes that are close to a receiver, but outside the range of a transmitter). Hidden nodes may occur when STAs 115 and APs 105 are spread throughout an area and a relatively high number of retransmissions occur on a wireless local area network (WLAN). Channel conditions may thus be used to determine when the RTS/CTS procedures are used. However, the decision to implement RTS/CTS procedures may also be autonomously decided for each STA 115.

An AP 105 may enable the use of RTS/CTS procedures by setting a traffic metric threshold for the STAs 115 in a BSS. For example, the AP 105 may set a specific packet size threshold (e.g., a threshold between 0 and 2347 bytes) in an information element carried in a management frame. As a result, if a STA 115 has packets to send that are greater than a certain number of bytes, the AP 105 may direct the STA 115 to use RTS/CTS procedures. Additionally or alternatively, as described herein, the AP 105 may set protection mechanism bits (e.g., protection mechanism bits that may be used in the presence of STAs 115 operating according to a certain IEEE 802.11 version, such as 802.11b or 802.11g) within management frames to indicate the use of the RTS/CTS mode at one or more STAs 115. For instance, the AP 105 may set protection mechanism bits (e.g., a Use_Protection bit) within beacon frames or probe response frames to direct STAs 115 to use the RTS/CTS mode, and the AP 105 may in turn perform power saving and off channel operations. In some cases, an AP 105 may refrain from using RTS/CTS procedures itself, as all wireless nodes may be associated with it and increased efficiency may be achieved by implementing RTS/CTS at each STA 115.

In some cases there may be no designated mechanism that allows an AP 105 to go into a power save or sleep mode (e.g., powering down all power-collapsible hardware, MAC, and RF components or powering down some RF chains of a radio) or perform off-channel operations (e.g., performing an active scan outside of the operating channel or maintaining a connection to another BSS on a different channel) while maintaining the existing connection. For example, an AP 105, such as a software enabled AP (SoftAP) (e.g., a phone-based AP 105), may send a CTS-to-self and perform off-channel operations. However, the transmission of the CTS-to-self frame may only allow the AP 105 to operate off-channel for a limited duration of time (e.g., a maximum of 32.765 ms or the maximum of a CTS timeout). Additionally, while the CTS-to-self mechanism may enable an AP 105 to perform off-channel operations (or power save procedures), this may impact the overall efficiency of the WLAN 100. That is, the CTS-to-self transmission may prevent traffic in this and any adjacent BSSs leading to an inefficient disruption of communications.

As described herein, an AP 105 may direct STAs 115 to use an RTS/CTS mode so the AP 105 may perform power savings or off-channel operations without disrupting the communications of nearby devices. In some cases, the AP 105 may use traffic conditions to identify a power save period and subsequently transmit an indication of an RTS/CTS mode to multiple STAs 115. In one example, the AP 105 may power down at least one radio chain (e.g., at least one RF chain) and enter into a sleep mode. Additionally or alternatively, during the power save period the AP 105 may receive an RTS from a STA 115 and power up additional radio chains to be used for MIMO communication. In some cases, the AP 105 may identify an off-channel operations period based on traffic conditions and perform the off-channel operations after indicating the RTS/CTS mode to a set of STAs 115.

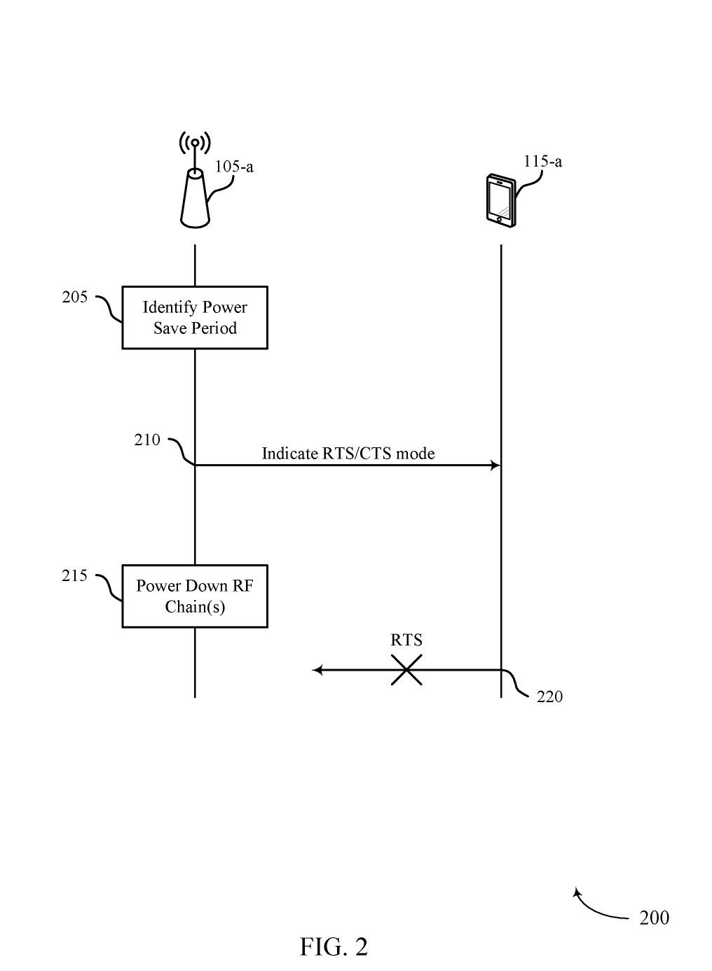

FIG. 2 illustrates an example of a process flow 200 in a system that supports RTS/CTS enabled power saving and off-channel operations in accordance with various aspects of the present disclosure. Process flow 200 includes AP 105-a and STA 115-a which may be examples of the corresponding devices as described with reference to FIG. 1. Process flow 200 may support efficient power save operations by an AP using the indication of an RTS/CTS mode.

In some cases, AP 105-a may direct STAs 115 (e.g., including STA 115-a) to use an RTS/CTS mode, where the RTS/CTS mode may entail the use of RTS/CTS procedures within a BSS (e.g., the STAs 115 may be required to use RTS/CTS procedures for communicating). In an example, the RTS/CTS mode may include an exchange of RTS and CTS between devices or the exchange of CTS between devices. Because AP 105-a may act as the central entity in a BSS, AP 105-a may have a complete view of the BSS, and may therefore monitor hidden nodes in the system based on various parameters. AP 105-a may direct RTS/CTS procedures for the purpose of congestion control, and may determine when to trigger the RTS/CTS mode based on opportunities to perform off-channel operations or go into a power save mode. In such cases, at step 205, AP 105-a may use traffic conditions to identify a power save period. For example, AP 105-a may determine that a traffic metric (e.g., a throughput measured in bits per second) for STAs 115 within a BSS is less than a threshold.

In some cases, the use of the RTS/CTS mode may be based on additional conditions. For example, the length of the power save period may be identified based on a roaming trigger parameter for STA 115-a, such as a parameter that enables STA 115-a to determine whether a connection with AP 105-a is still active. For example, STA 115-a may use a timer (e.g., a keepalive timer), where, if no response is received from AP 105-a at the expiration of the timer, STA 115-a may assume the connection with AP 105-a is no longer active or AP 105-a is not available and STA 115-a may disconnect and/or roam to another AP 105. In some examples, AP 105-a may configure STA 115-a to send RTS for frames that are longer than (or satisfy) a certain threshold length, or if STA 115-a is relatively a long distance away from AP 105-a, etc. In some cases, AP 105-a may determine that a traffic metric for STAs 115 within a BSS is less than (or does not satisfy) a threshold and identify a power save opportunity based on the traffic metric.

At step 210, AP 105-a may transmit an indication of the RTS/CTS mode for the power save period. The indication may direct STA 115-a to use the RTS/CTS mode during the power save period. In some cases, transmitting the indication of the RTS/CTS mode includes setting an RTS/CTS packet size threshold to zero. Additionally or alternatively, AP 105-a may set a protection bit (e.g., a 802.11b/802.11g protection bit) within one or more management frames (e.g., beacon frames) to indicate the RTS/CTS mode. In some examples, the protection bits in management frames sent from AP 105-a to STA 115-a may be set to indicate the RTS/CTS mode whether or not other STAs 115 (e.g., a different STA 115 operating according to the 802.11b or 802.11g versions) are present in the system. At step 215, AP 105-a may then power down at least one RF chain during the power save period based on the RTS/CTS mode indication. In some cases, powering down at least one RF chain includes powering down each RF chain of a device according to a sleep mode configuration (e.g., a configuration that determines how RF chains may go into a low power state). Powering down at least one RF chain may also include powering down all power-collapsible hardware, RF, and MAC components of the device (e.g., hardware, RF and MAC components that are able to power down during a sleep mode).

At step 220, STA 115-a may transmit an RTS message to AP 105-a, but AP 105-a may not receive the message since it may be in a low power mode (i.e., AP 105-a may not have any receive chain powered up and tuned to receive the RTS). Thus, STA 115-a may not transmit the data associated with the RTS message and may wait for a subsequent opportunity.

In some examples, AP 105-a may employ this mechanism for a limited amount of time to avoid any impact on STAs 115 within the BSS. For example, STA 115-a may continually attempt the RTS procedures, and eventually STA 115-a may roam to a different AP 105 due to the absence of a CTS response. Thus, AP 105-a may direct the use of the RTS/CTS mode for a certain duration (e.g., less than 1.5 seconds, or the length of time to avoid roaming trigger decisions). As a result, directing STA 115-a to use the RTS/CTS mode may provide an efficient way for AP 105-a to save power while not impacting transmission rates associated with multiple STAs 115, including STA 115-a (as may be the case if AP 105-a enters the power save period without notice), or by causing adverse impact to other communications in the BSS or OBSS (as may be the case when a CTS-to-self is transmitted).

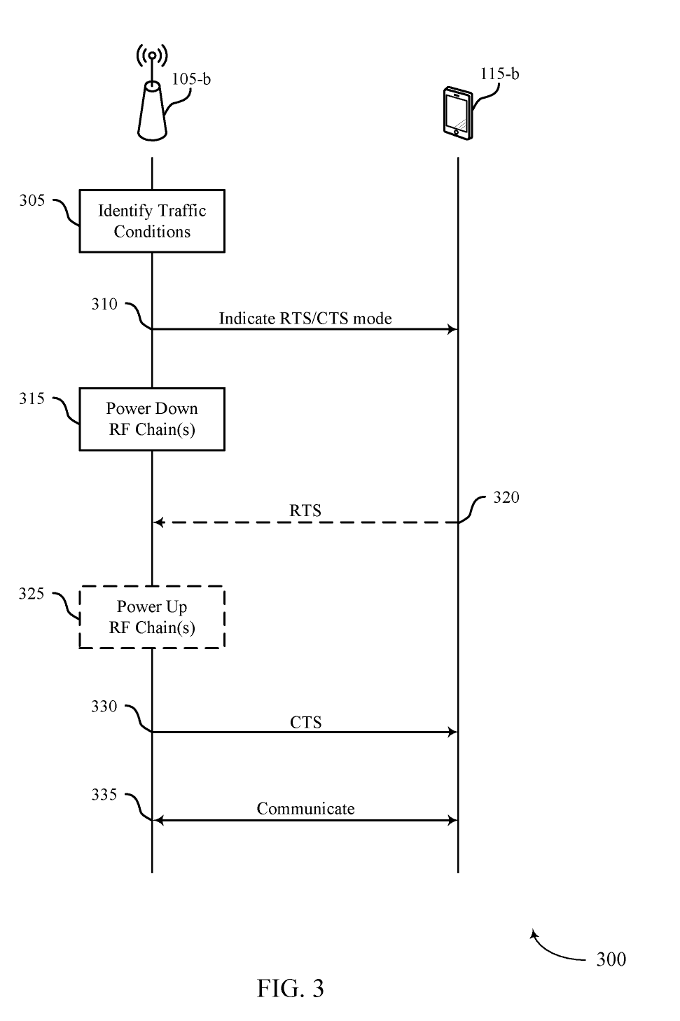

FIG. 3 illustrates an example of a process flow 300 in a system that supports RTS/CTS enabled power saving and off-channel operations in accordance with various aspects of the present disclosure. Process flow 300 includes an AP 105-b and STA 115-b which may be examples of the corresponding devices as described with reference to FIGS. 1 and 2. Process flow 300 may support efficient power save processes by AP 105-b by powering down radio chains (i.e., RF chains) following the indication of an RTS/CTS mode.

In some cases, AP 105-b may indicate an RTS/CTS mode so that it may turn off RF chains to save power. For example, a MIMO-capable AP 105 (e.g., AP 105-b) in a light or sporadic wireless traffic environment may dynamically power down multiple RF chains (e.g., where the RF chains enter into a low power state) and keep at least one RF chain active. Thus, at step 305, AP 105-b may use traffic conditions to identify a power save period, where the power save period may be identified based on a roaming trigger parameter for STA 115-b (e.g., a parameter that enables STA 115-b to determine whether AP 105-b is still active). As mentioned above, AP 105-b may determine that a traffic metric for STAs 115 within a BSS (including STA 115-b) is less than a threshold.

At step 310, AP 105-b may transmit an indication of an RTS/CTS mode for the power save period. The indication may direct STA 115-b to use the RTS/CTS mode during the power save period. In some cases, transmitting the indication of the RTS/CTS mode includes setting an RTS/CTS packet size threshold to zero. In some cases, transmitting the indication of the RTS/CTS mode includes setting a protection bit in one or more management frames to indicate the RTS/CTS mode. At step 315, AP 105-b may power down at least one RF chain during the power save period based on the RTS/CTS mode. In some cases, powering down at least one RF chain includes powering down each RF chain of a device according to a sleep mode configuration.

At step 320, STA 115-b may transmit an RTS message to AP 105-b if STA 115-b has data to send over the wireless medium. If AP 105-b receives the RTS frame from STA 115-b, AP 105-b may power up one or more RF chains based on the capability of STA 115-b with which multiple spatial streams have been negotiated in the uplink direction. Thus, at step 325, AP 105-b may power up one or more RF chains for MIMO communications based at least in part on the identified number of RF chains. In some examples, AP 105-b may refrain from powering up all of its RF chains to maintain power savings during the power save period. Thus, AP 105-b may receive the RTS message from STA 115-b during the power save period according to the RTS/CTS mode, and AP 105-b may identify a number of RF chains for MIMO communications with STA 115-b based on the RTS message.

AP 105-b may subsequently transmit a CTS message to STA 115-b in response to the received RTS message at step 330. At step 335, following receipt of the CTS message at STA 115-b, AP 105-b and STA 115-b may communicate during the power save period using an additional RF chain, where the at least one RF chain and the additional RF chain include different RF chains of a MIMO configuration.

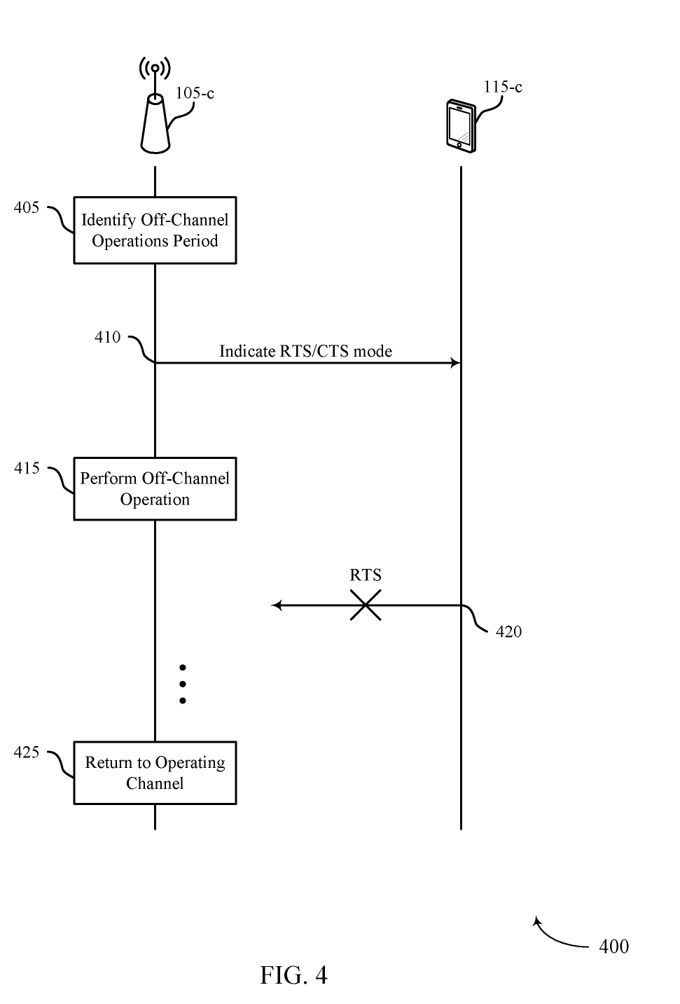

FIG. 4 illustrates an example of a process flow 400 for a system that supports RTS/CTS enabled power saving and off-channel operations in accordance with various aspects of the present disclosure. Process flow 400 includes an AP 105-c and STA 115-c which may be examples of the corresponding devices as described with reference to FIGS. 1, 2, and 3. Process flow 400 may support efficient off-channel operations by AP 105-c using the indication of an RTS/CTS mode.

In some cases, AP 105-c may direct at least one STA 115 (e.g., including STA 115-c) to use RTS/CTS procedures to perform off-channel operations. Thus, at step 405 AP 105-c may identify an off-channel operations period. In some cases, the off-channel operations period is identified based on a roaming trigger parameter for a STA.

If AP 105-c decides to go off-channel, such as to support multi-channel concurrency operations, AP 105-c may direct all of its associated STAs 115 e.g. to send RTS before sending uplink packets. At step 410, AP 105-c may transmit an indication of an RTS/CTS mode for the off-channel operations period. In some cases the indication may be transmitted on a first channel, and the indication may direct all STAs 115 within a BSS (including STA 115-c) to utilize the RTS/CTS mode during the off-channel operations period. In some examples, transmitting the indication of the RTS/CTS mode includes setting an RTS/CTS packet size threshold to zero. In some cases, transmitting the indication of the RTS/CTS mode includes setting a protection bit in one or more management frames to indicate the RTS/CTS mode.

At step 415, AP 105-c may perform off-channel operations on a second channel during the off-channel operations period based on the RTS/CTS mode. In some cases, the off-channel operations include components of a multi-channel concurrency operation. Once AP 105-c is off-channel, it may not respond to incoming RTS transmissions with a CTS frame, and at step 420, an RTS sent by STA 115-c may not be received. STA 115-c may assume the channel is busy and wait for a period of time and retry the RTS transmission.

In some examples, AP 105-c may remain off-channel for a certain period of time to minimize any impact of STA 115-c being unable to receive a response CTS frame, as discussed above. As a result, AP 105-c may make a careful selection of the off-channel duration. Upon the expiration of the off-channel operations period, AP 105-c may return to the operating channel at step 425 to allow communications with at least one STA 115.

As mentioned above, a CTS-to-self frame transmission may impair the entire BSS and any other co-channel BSSs from communication, but may also require multiple transmission of CTS-to-self frames (e.g., at a 32.765 ms periodicity) to achieve relatively long periods of off-channel operation (e.g., close to 100 ms of off-channel operation). By directing STAs 115 to use the RTS/CTS mode, the BSS may not be impacted in the same manner as with CTS-to-self operations. Therefore, greater durations of off-channel operations (e.g., than the CTS-to-self mechanism can provide) may be achieved, for example, in one contiguous slot. Similarly, the duration of off-channel operations may be dynamically chosen to prevent STAs 115 from roaming to another AP 105.

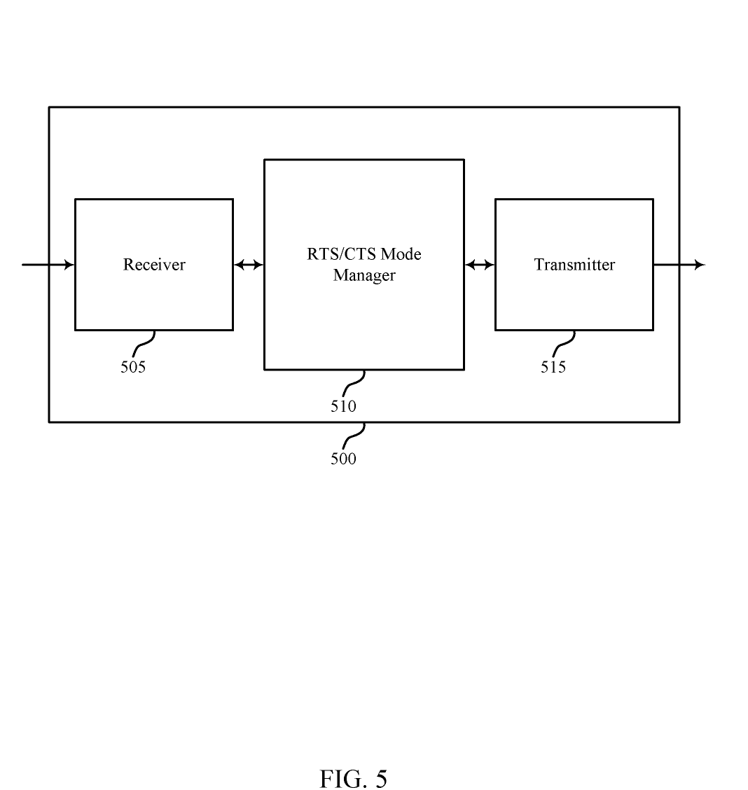

FIG. 5 shows a block diagram of a wireless device 500 that supports RTS/CTS enabled power saving and off-channel operations in accordance with various aspects of the present disclosure. Wireless device 500 may be an example of aspects of an AP 105 as described with reference to FIGS. 1 through 4. Wireless device 500 may include receiver 505, RTS/CTS mode manager 510, and transmitter 515. Wireless device 500 may also include a processor. Each of these components may be in communication with each other.

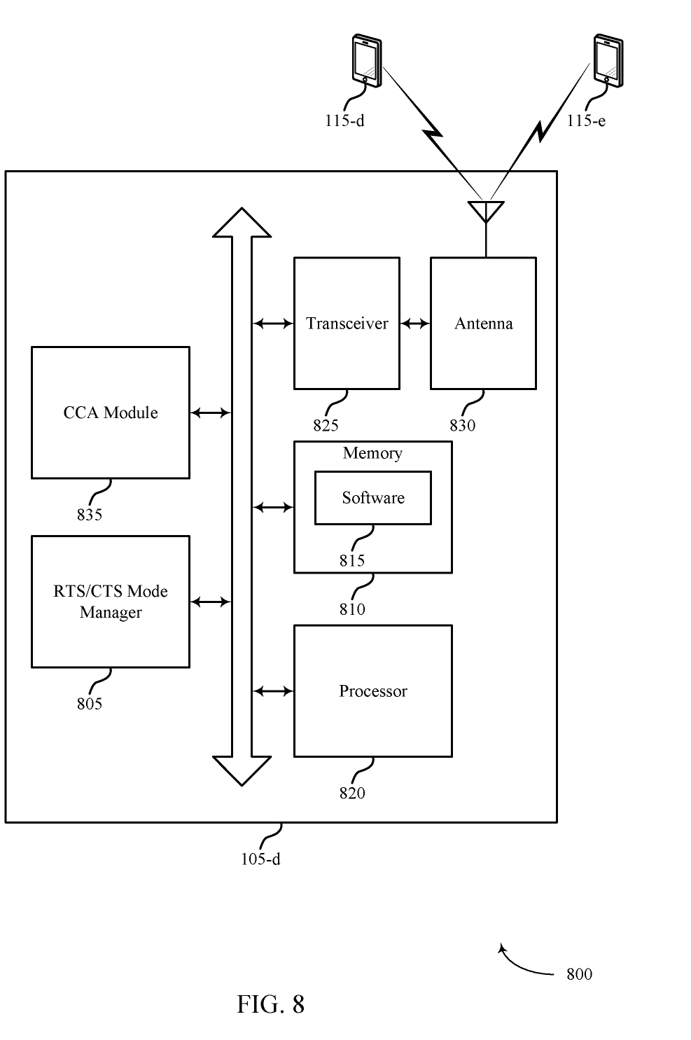

The receiver 505 may receive information such as packets, user data, or control information associated with various information channels (e.g., control channels, data channels, and information related to RTS/CTS enabled power saving and off-channel operations, etc.). Information may be passed on to other components of the device. The receiver 505 may be an example of aspects of the transceiver 825 as described with reference to FIG. 8.

The RTS/CTS mode manager 510 may identify an off-channel operations period, transmit an indication of an RTS/CTS mode for the off-channel operations period, where the indication is transmitted on a first channel, perform off-channel operations on a second channel during the off-channel operations period based on the RTS/CTS mode, and identify a power save period based on a traffic condition. Additionally, the RTS/CTS mode manager 510 may transmit an indication of an RTS/CTS mode for the power save period, and power down at least one radio chain during the power save period based on the RTS/CTS mode. The RTS/CTS mode manager 510 may also be an example of aspects of the RTS/CTS mode manager 805 as described with reference to FIG. 8.

The transmitter 515 may transmit signals received from other components of wireless device 500. In some examples, the transmitter 515 may be collocated with a receiver in a transceiver module. For example, the transmitter 515 may be an example of aspects of the transceiver 825 as described with reference to FIG. 8. The transmitter 515 may include a single antenna, or it may include a plurality of antennas.

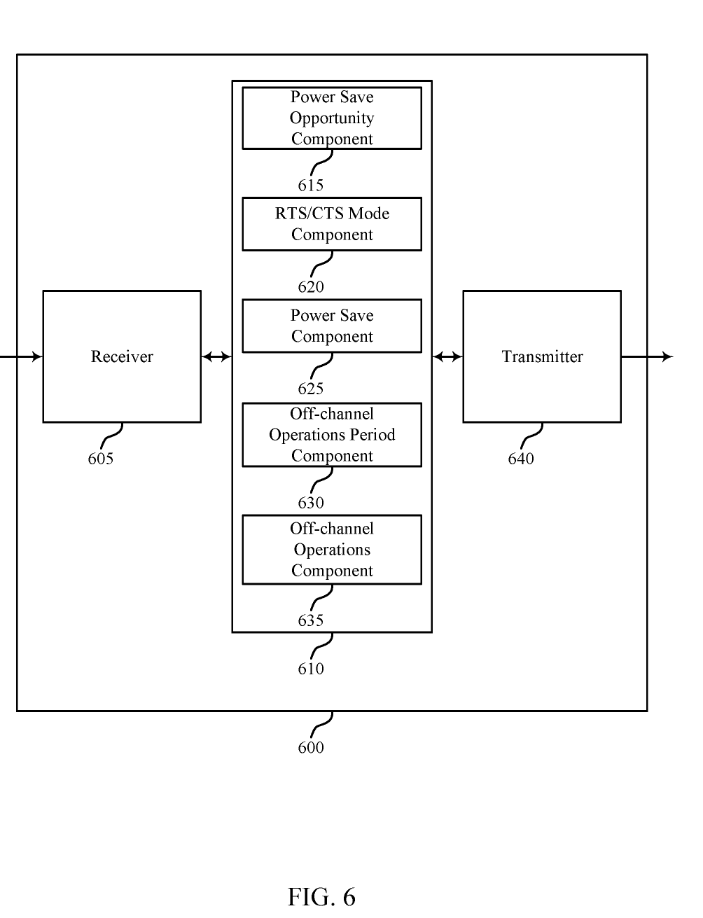

FIG. 6 shows a block diagram of a wireless device 600 that supports RTS/CTS enabled power saving and off-channel operations in accordance with various aspects of the present disclosure. Wireless device 600 may be an example of aspects of a wireless device 500 or an AP 105 as described with reference to FIGS. 1 through 5. Wireless device 600 may include receiver 605, RTS/CTS mode manager 610 and transmitter 640. Wireless device 600 may also include a processor. Each of these components may be in communication with each other.

The receiver 605 may receive information which may be passed on to other components of the device. The receiver 605 may also perform the functions as described with reference to the receiver 505 of FIG. 5. The receiver 605 may be an example of aspects of the transceiver 825 as described with reference to FIG. 8.

The RTS/CTS mode manager 610 may be an example of aspects of RTS/CTS mode manager 510 as described with reference to FIG. 5. The RTS/CTS mode manager 610 may include power save opportunity component 615, RTS/CTS mode component 620, power save component 625, off-channel operations period component 630 and off-channel operations component 635. The RTS/CTS mode manager 610 may be an example of aspects of the RTS/CTS mode manager 805 as described with reference to FIG. 8. The power save opportunity component 615 may identify a power save period based on a traffic condition. In some cases, the power save period can be identified based on a roaming trigger parameter for a STA 115, such as a parameter that enables the STA 115 to determine whether a connection with an AP 105 is still active. For example, a STA 115 may use a timer (e.g., a keepalive timer), where, if no response is received from an AP 105 at the expiration of the timer, the STA 115 may assume the connection with the AP 105 is no longer active or the AP 105 is not available and the STA 115 may disconnect and/or roam to another AP 105.

The RTS/CTS mode component 620 may transmit an indication of an RTS/CTS mode for the off-channel operations period, where the indication is transmitted on a first channel. Additionally or alternatively, the RTS/CTS mode component 620 may transmit an indication of an RTS/CTS mode for the power save period. In either case, the indication directs STAs 115 within a BSS to utilize the RTS/CTS mode during the off-channel operations period or the power save period. In some cases, transmitting the indication of the RTS/CTS mode includes setting an RTS/CTS packet size threshold to zero. In some cases, transmitting the indication of the RTS/CTS mode includes setting a protection bit in one or more management frames to indicate the RTS/CTS mode.

The power save component 625 may power up one or more radio chains for MIMO communications based on an identified number of radio chains, and power down at least one radio chain during the power save period based on the RTS/CTS mode. In some cases, powering down the at least one radio chain includes powering down each radio chain of a device according to a sleep mode configuration. The off-channel operations period component 630 may identify the off-channel operations period. In some cases, the off-channel operations period is identified based on a roaming trigger parameter for a STA 115.

The off-channel operations component 635 may perform off-channel operations on a second channel during the off-channel operations period based on the RTS/CTS mode. In some cases, the off-channel operations include a component of a multi-channel concurrency operation. The transmitter 640 may transmit signals received from other components of wireless device 600. In some examples, the transmitter 640 may be collocated with a receiver in a transceiver module. For example, the transmitter 640 may be an example of aspects of the transceiver 825 as described with reference to FIG. 8. The transmitter 640 may utilize a single antenna, or it may utilize a plurality of antennas.

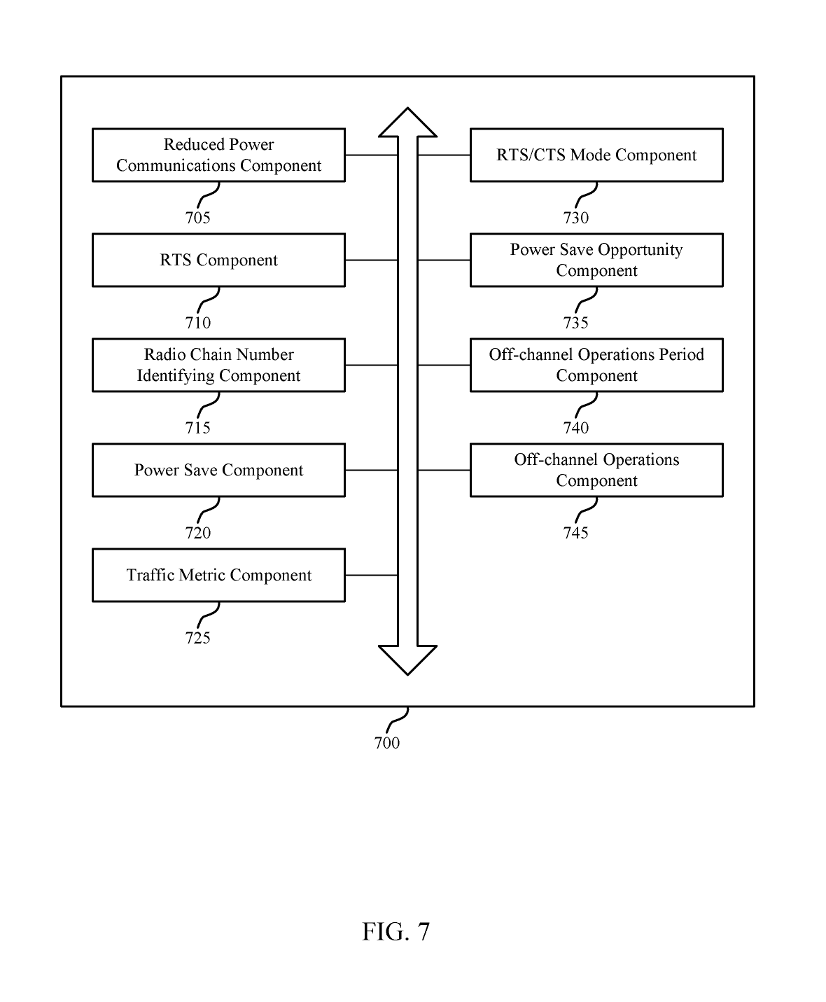

FIG. 7 shows a block diagram of an RTS/CTS mode manager 700 which may be an example of the corresponding component of wireless device 500 or wireless device 600. That is, RTS/CTS mode manager 700 may be an example of aspects of RTS/CTS mode manager 510 or RTS/CTS mode manager 610 as described with reference to FIGS. 5 and 6. The RTS/CTS mode manager 700 may also be an example of aspects of the RTS/CTS mode manager 805 as described with reference to FIG. 8.

The RTS/CTS mode manager 700 may include reduced power communications component 705, RTS component 710, radio chain number identifying component 715, power save component 720, traffic metric component 725, RTS/CTS mode component 730, power save opportunity component 735, off-channel operations period component 740, and off-channel operations component 745. Each of these modules may communicate, directly or indirectly, with one another (e.g., via at least one bus).

The reduced power communications component 705 may communicate, during a power save period, using an additional radio chain, where at least one radio chain and the additional radio chain include different radio chains of a MIMO configuration. The RTS component 710 may receive an RTS message from a STA 115 during the power save period according to the RTS/CTS mode. The radio chain number identifying component 715 may identify a number of radio chains for MIMO communications with the STA 115 based on the RTS message.

The power save component 720 may power up one or more radio chains for MIMO communications based on the identified number of radio chains, and power down at least one radio chain during the power save period based on an RTS/CTS mode. The traffic metric component 725 may determine that a traffic metric (e.g., a throughput measured in bits per second) for STAs 115 within a BSS is less than a threshold, where the power save period may be identified based at least in part on the determination that the traffic metric is less than the threshold.

The RTS/CTS mode component 730 may transmit an indication of the RTS/CTS mode for an off-channel operations period, where the indication is transmitted on a first channel. Additionally or alternatively, the RTS/CTS mode component 730 may transmit an indication of an RTS/CTS mode for the power save period. The power save opportunity component 735 may identify a power save period based on a traffic condition. The off-channel operations period component 740 may identify the off-channel operations period, which may be identified based on a roaming trigger parameter for the STA 115. The off-channel operations component 745 may perform off-channel operations on a second channel during the off-channel operations period based on the RTS/CTS mode.

FIG. 8 shows a diagram of a system 800 including a device that supports RTS/CTS enabled power saving and off-channel operations in accordance with various aspects of the present disclosure. For example, system 800 may include AP 105-d, which may be an example of a wireless device 500, a wireless device 600, or an AP 105 as described with reference to FIGS. 1 through 7.

AP 105-d may also include RTS/CTS mode manager 805, memory 810, processor 820, transceiver 825, antenna 830 and CCA module 835. Each of these modules may communicate, directly or indirectly, with one another (e.g., via at least one buses). The RTS/CTS mode manager 805 may be an example of an RTS/CTS mode manager as described with reference to FIGS. 5 through 7.

The memory 810 may include random access memory (RAM) and read only memory (ROM). The memory 810 may store computer-readable, computer-executable software including instructions that, when executed, cause the processor to perform various functions described herein (e.g., RTS/CTS enabled power saving and off-channel operations, etc.). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.).

The transceiver 825 may communicate bi-directionally, via at least one antenna, wired, or wireless links, with at least one network, as described above. For example, the transceiver 825 may communicate bi-directionally with an AP 105 or a STA 115. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions. CCA module 835 may enable listen-before-talk (LBT) procedures in unlicensed spectrum, such as a CCA as described above with reference to FIG. 1.

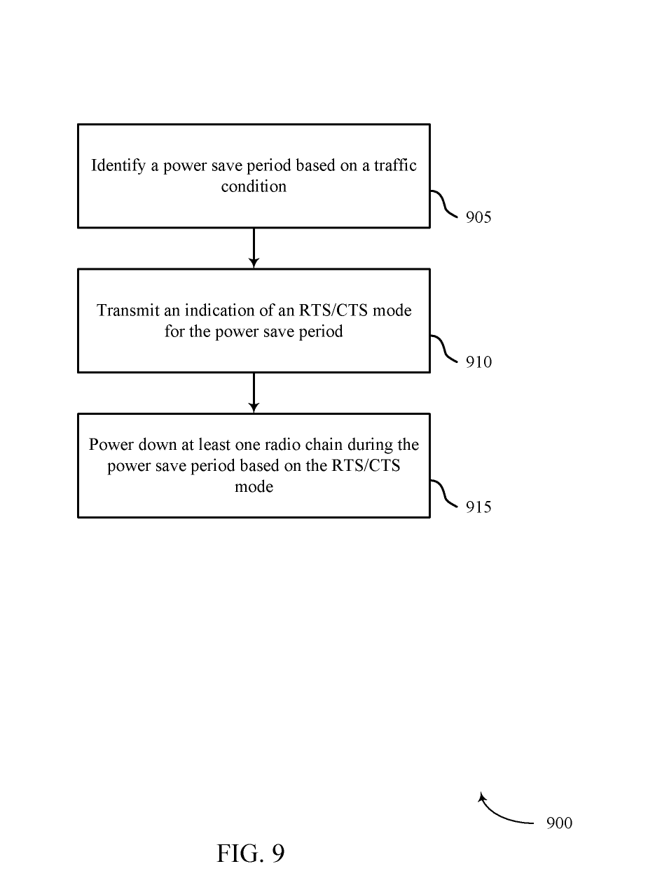

FIG. 9 shows a flowchart illustrating a method 900 for RTS/CTS enabled power saving and off-channel operations in accordance with various aspects of the present disclosure. The operations of method 900 may be implemented by a device such as an AP 105 or its components as described with reference to FIGS. 1 through 4. For example, the operations of method 900 may be performed by the RTS/CTS mode manager as described herein. In some examples, the AP 105 may execute a set of codes to control the functional elements of the device to perform the functions described below. Additionally or alternatively, the AP 105 may perform aspects of the functions described below using special-purpose hardware.

At block 905, the AP 105 may identify a power save period based on a traffic condition as described above with reference to FIGS. 2 through 4. In some examples, the operations of block 905 may be performed by the power save opportunity component as described with reference to FIG. 6.

At block 910, the AP 105 may transmit an indication of an RTS/CTS mode for the power save period as described above with reference to FIGS. 2 through 4. In some examples, the operations of block 910 may be performed by the RTS/CTS mode component as described with reference to FIG. 6.

At block 915, the AP 105 may power down at least one radio chain during the power save period based on the RTS/CTS mode as described above with reference to FIGS. 2 through 4. In some cases, powering down at least one radio chain includes powering down all power-collapsible hardware, RF, and MAC components of a device. In some examples, the operations of block 915 may be performed by the power save component as described with reference to FIG. 6.

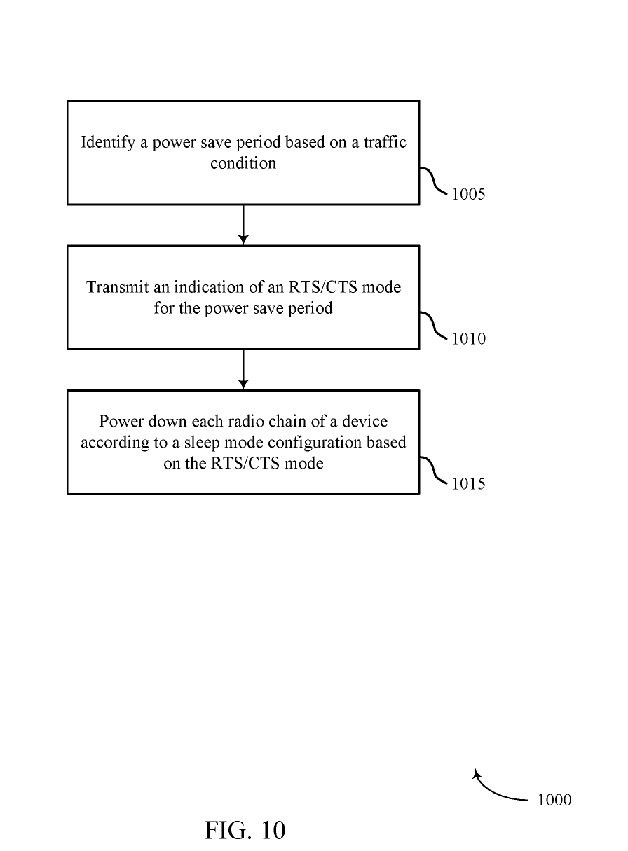

FIG. 10 shows a flowchart illustrating a method 1000 for RTS/CTS enabled power saving and off-channel operations in accordance with various aspects of the present disclosure. The operations of method 1000 may be implemented by a device such as an AP 105 or its components as described with reference to FIGS. 1 through 4. For example, the operations of method 1000 may be performed by the RTS/CTS mode manager as described herein. In some examples, the AP 105 may execute a set of codes to control the functional elements of the device to perform the functions described below. Additionally or alternatively, the AP 105 may perform aspects of the functions described below using special-purpose hardware.

At block 1005, the AP 105 may identify a power save period based on a traffic condition as described above with reference to FIGS. 2 through 4. In some examples, the operations of block 1005 may be performed by the power save opportunity component as described with reference to FIG. 6.

At block 1010, the AP 105 may transmit an indication of an RTS/CTS mode for the power save period as described above with reference to FIGS. 2 through 4. In some examples, the operations of block 1010 may be performed by the RTS/CTS mode component as described with reference to FIG. 6.

At block 1015, the AP 105 may power down each radio chain of a device according to a sleep mode configuration based on the RTS/CTS mode. In some examples, the operations of block 1015 may be performed by the power save component as described with reference to FIG. 6.

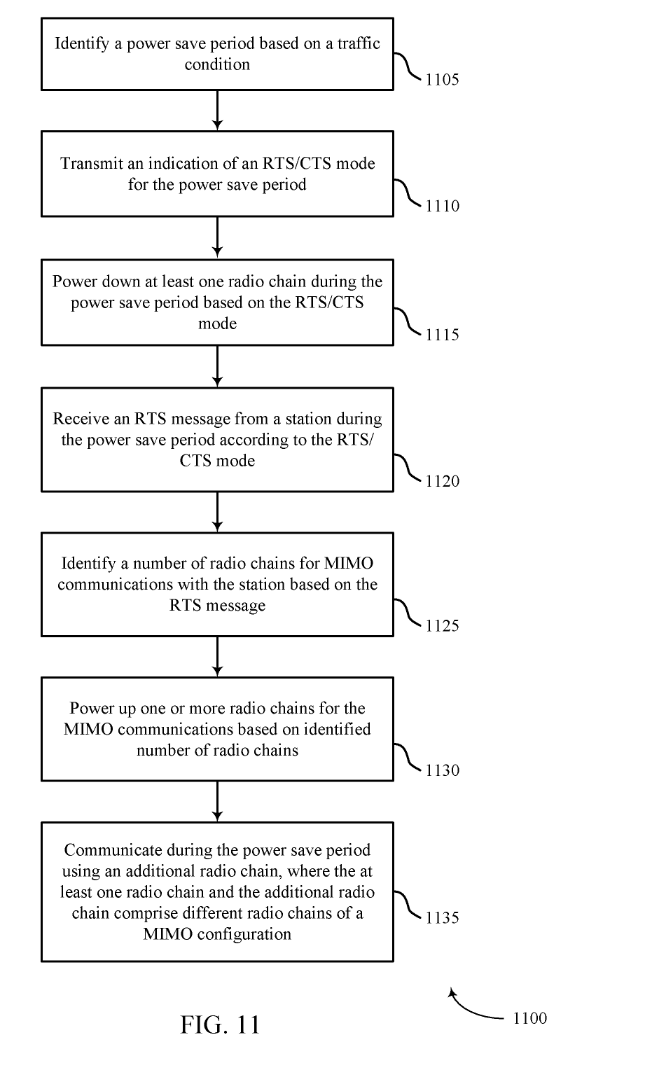

FIG. 11 shows a flowchart illustrating a method 1100 for RTS/CTS enabled power saving and off-channel operations in accordance with various aspects of the present disclosure. The operations of method 1100 may be implemented by a device such as an AP 105 or its components as described with reference to FIGS. 1 through 4. For example, the operations of method 1100 may be performed by the RTS/CTS mode manager as described herein. In some examples, the AP 105 may execute a set of codes to control the functional elements of the device to perform the functions described below. Additionally or alternatively, the AP 105 may perform aspects of the functions described below using special-purpose hardware.

At block 1105, the AP 105 may identify a power save period based on a traffic condition as described above with reference to FIGS. 2 through 4. In some examples, the operations of block 1105 may be performed by the power save opportunity component as described with reference to FIG. 6.

At block 1110, the AP 105 may transmit an indication of an RTS/CTS mode for the power save period as described above with reference to FIGS. 2 through 4. In some examples, the operations of block 1110 may be performed by the RTS/CTS mode component as described with reference to FIG. 6.

At block 1115, the AP 105 may power down at least one radio chain during the power save period based on the RTS/CTS mode as described above with reference to FIGS. 2 through 4. In some examples, the operations of block 1115 may be performed by the power save component as described with reference to FIG. 6.

At block 1120, the AP 105 may receive an RTS message from a STA 115 during the power save period according to the RTS/CTS mode as described above with reference to FIGS. 2 through 4. In some examples, the operations of block 1120 may be performed by the RTS component as described with reference to FIG. 6.

At block 1125, the AP 105 may identify a number of radio chains for MIMO communications with the STA 115 based on the RTS message as described above with reference to FIGS. 2 through 4. In some examples, the operations of block 1125 may be performed by the radio chain number identifying component as described with reference to FIG. 6.

At block 1130, the AP 105 may power up one or more radio chains for the MIMO communications based on the identified number of radio chains as described above with reference to FIGS. 2 through 4. In some examples, the operations of block 1130 may be performed by the power save component as described with reference to FIG. 6.

At block 1135, the AP 105 may communicate, during the power save period, using an additional radio chain, where the at least one radio chain and the additional radio chain include different radio chains of the MIMO configuration as described above with reference to FIGS. 2 through 4. In some examples, the operations of block 1135 may be performed by the reduced power communications component as described with reference to FIG. 6.

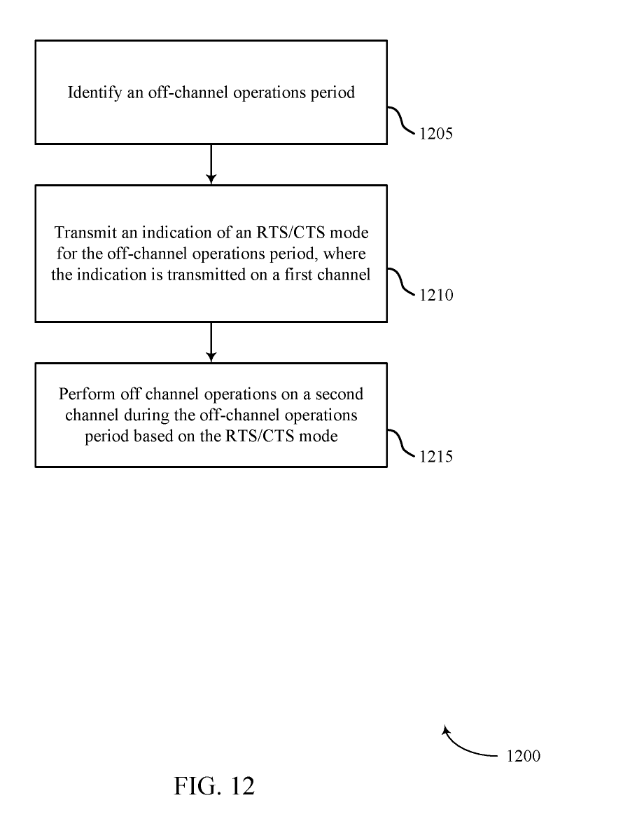

FIG. 12 shows a flowchart illustrating a method 1200 for RTS/CTS enabled power saving and off-channel operations in accordance with various aspects of the present disclosure. The operations of method 1200 may be implemented by a device such as an AP 105 or its components as described with reference to FIGS. 1 and 2. For example, the operations of method 1200 may be performed by the RTS/CTS mode manager as described herein. In some examples, the AP 105 may execute a set of codes to control the functional elements of the device to perform the functions described below. Additionally or alternatively, the AP 105 may perform aspects of the functions described below using special-purpose hardware.

At block 1205, the AP 105 may identify an off-channel operations period as described above with reference to FIGS. 2 through 4. In some examples, the operations of block 1205 may be performed by the off-channel operations period component as described with reference to FIG. 6.

At block 1210, the AP 105 may transmit an indication of an RTS/CTS mode for the off-channel operations period, where the indication is transmitted on a first channel as described above with reference to FIGS. 2 through 4. In some examples, the operations of block 1210 may be performed by the RTS/CTS mode component as described with reference to FIG. 6.

At block 1215, the AP 105 may perform off-channel operations on a second channel during the off-channel operations period based on the RTS/CTS mode as described above with reference to FIGS. 2 through 4. In some examples, the operations of block 1215 may be performed by the off-channel operations component as described with reference to FIG. 6.

In some examples, aspects from two or more of the methods 900, 1000, 1100, and 1200 as described with reference to FIGS. 9, 10, 11, and 12 may be combined. It should be noted that the methods 900, 1000, 1100, and 1200 are just example implementations, and that the operations of the methods 900, 1000, 1100, and 1200 may be rearranged or otherwise modified such that other implementations are possible.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C., as well as any combination with multiples of the same element (e.g., A-A, A-A-A, A-A-B, A-A-C, A-B-B, A-C-C, B-B, B-B-B, B-B-C, C-C, and C-C-C or any other ordering of A, B, and C).

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The wireless communications system, WLANs, or systems described herein may support synchronous or asynchronous operation. For synchronous operation, the base STAs may have similar frame timing, and transmissions from different base STAs may be approximately aligned in time. For asynchronous operation, the base STAs may have different frame timing, and transmissions from different base STAs may not be aligned in time. The techniques described herein may be used for either synchronous or asynchronous operations.

Thus, aspects of the disclosure may provide for RTS/CTS enabled power saving and off-channel operations. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, at least one microprocessor in conjunction with a DSP core, or any other such configuration). Thus, the functions described herein may be performed by at least one other processing unit (or core), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by at least one general or application-specific processor.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
identifying, by an access point (AP), a power save period based at least in part on a traffic condition;
transmitting, from the AP, an indication of a request-to-send (RTS)/clear-to-send (CTS) mode for the power save period; and
powering down at least one radio chain during the power save period based at least in part on the RTS/CTS mode.

2. The method of claim 1, wherein powering down the at least one radio chain comprises:
powering down each radio chain of a device according to a sleep mode configuration.

3. The method of claim 1, wherein powering down the at least one radio chain comprises:
powering down all power-collapsible hardware components, radio frequency (RF) components, and medium access control (MAC) components of a device.

4. The method of claim 1, further comprising:
communicating, during the power save period, using an additional radio chain, wherein the at least one radio chain and the additional radio chain comprise different radio chains of a multiple-input multiple-output (MIMO) configuration.

5. The method of claim 4, further comprising:
receiving an RTS message from a station during the power save period according to the RTS/CTS mode;
identifying a number of radio chains for MIMO communications with the station based at least in part on the RTS message; and
powering up one or more radio chains for the MIMO communications based at least in part on identified number of radio chains.

6. The method of claim 1, further comprising:
determining that a traffic metric for stations within a basic service set (BSS) is less than a threshold, wherein the power save period is identified based at least in part on the determination that the traffic metric is less than the threshold.

7. The method of claim 1, wherein the indication directs stations within a basic service set (BSS) to utilize the RTS/CTS mode during the power save period.

8. The method of claim 1, wherein the power save period is identified based at least in part on a roaming trigger parameter for a station.

9. The method of claim 1, wherein transmitting the indication of the RTS/CTS mode comprises:
setting an RTS/CTS packet size threshold to zero.

10. The method of claim 1, wherein transmitting the indication of the RTS/CTS mode comprises:
setting a protection bit in one or more management frames to indicate the RTS/CTS mode.

11. A method of wireless communication comprising:
identifying an off-channel operations period;
transmitting an indication of a request-to-send (RTS)/clear-to-send (CTS) mode for the off-channel operations period, wherein the indication is transmitted on a first channel; and
performing off-channel operations on a second channel during the off-channel operations period based at least in part on the RTS/CTS mode.

12. The method of claim 11, wherein the off-channel operations comprise a component of a multi-channel concurrency operation.

13. The method of claim 11, wherein the indication directs all stations within a basic service set (BSS) to utilize the RTS/CTS mode during the off-channel operations period.

14. The method of claim 11, wherein the off-channel operations period is identified based at least in part on a roaming trigger parameter for a station.

15. The method of claim 11, wherein transmitting the indication of the RTS/CTS mode comprises:
setting an RTS/CTS packet size threshold to zero.

16. The method of claim 11, wherein transmitting the indication of the RTS/CTS mode comprises:
setting a protection bit in one or more management frames to indicate the RTS/CTS mode.

17. An apparatus for wireless communication, comprising:
a processor;
memory in electronic communication with the processor; and
instructions stored in the memory and operable, when executed by the processor, to cause the apparatus to:
identify, by an access point (AP), a power save period based at least in part on a traffic condition;
transmit, from the AP, an indication of a request-to-send (RTS)/clear-to-send (CTS) mode for the power save period; and
power down at least one radio chain during the power save period based at least in part on the RTS/CTS mode.

18. The apparatus of claim 17, wherein the instructions operable to cause the processor to power down the at least one radio chain are operable to cause the processor to:
power down each radio chain of a device according to a sleep mode configuration.

19. The apparatus of claim 17, wherein the instructions operable to cause the processor to power down the at least one radio chain are operable to cause the processor to:
power down all power-collapsible hardware components, radio frequency (RF) components, and medium access control (MAC) components of a device.

20. The apparatus of claim 17, wherein the instructions are operable to cause the processor to:
communicate, during the power save period, using an additional radio chain, wherein the at least one radio chain and the additional radio chain comprise different radio chains of a multiple-input multiple-output (MIMO) configuration.

21. The apparatus of claim 20, wherein the instructions are operable to cause the processor to:
receive an RTS message from a station during the power save period according to the RTS/CTS mode;
identify a number of radio chains for MIMO communications with the station based at least in part on the RTS message; and
power up one or more radio chains for the MIMO communications based at least in part on identified number of radio chains.

22. The apparatus of claim 17, wherein the instructions are operable to cause the processor to:
determine that a traffic metric for stations within a basic service set (BSS) is less than a threshold, wherein the power save period is identified based at least in part on the determination that the traffic metric is less than the threshold.

23. The apparatus of claim 17, wherein the indication directs stations within a basic service set (BSS) to utilize the RTS/CTS mode during the power save period.

24. The apparatus of claim 17, wherein the power save period is identified based at least in part on a roaming trigger parameter for a station.

25. The apparatus of claim 17, wherein the instructions operable to cause the processor to transmit the indication of the RTS/CTS mode are operable to cause the processor to:
set an RTS/CTS packet size threshold to zero.

26. An apparatus for wireless communication, comprising:
a processor;
memory in electronic communication with the processor; and
instructions stored in the memory and operable, when executed by the processor, to cause the apparatus to:
identify an off-channel operations period;
transmit an indication of a request-to-send (RTS)/clear-to-send (CTS) mode for the off-channel operations period, wherein the indication is transmitted on a first channel; and
perform off-channel operations on a second channel during the off-channel operations period based at least in part on the RTS/CTS mode.

27. The apparatus of claim 26, wherein the off-channel operations comprise a component of a multi-channel concurrency operation.

28. The apparatus of claim 26, wherein the indication directs all stations within a basic service set (BSS) to utilize the RTS/CTS mode during the off-channel operations period.

29. The apparatus of claim 26, wherein the off-channel operations period is identified based at least in part on a roaming trigger parameter for a station.

30. The apparatus of claim 26, wherein the instructions operable to cause the processor to transmit the indication of the RTS/CTS mode are operable to cause the processor to:
set an RTS/CTS packet size threshold to zero.
